(19) United States
(12) Patent Application Publication
(10) Pub. No.: US 2015/0079546 A1
(43) Pub. Date: Mar. 19, 2015

(54) ORIGAMI SHEET AND STENCIL THEREFOR

(71) Applicant: Brian Philip CRAIK SMITH, Sussex (GB)

(72) Inventor: Brian Philip Craik Smith, Sussex (GB)

(21) Appl. No.: 14/391,791

(22) PCT Filed: Apr. 9, 2013
(86) PCT No.: PCT/GB2013/050905

§ 371 Date: Oct. 10, 2014

(30) Foreign Application Priority Data
Apr. 10, 2012 (GB) 1206264.2

(51) Int. Cl. G09B 1/00

(52) U.S. Cl. CPC G09B 1/00
USPC 434/81

(57) ABSTRACT

Described is an origami sheet and a stencil for creating the origami sheet, wherein (i) the origami sheet is for folding into a model, the sheet comprising one or more indicators for indicating to a user where to make one or more cuts or tears in the origami sheet, such that, when the sheet is cut or torn as indicated by the one or more indicators and then folded a model is created with the resultant one or more cuts or tears creating a hole in the model through which the inner surface of the model is visible; and/or (ii) the origami sheet is an edible origami sheet for folding into a model; and/or (iii) the origami sheet is for folding into a model, the sheet comprising one or more textured model components, such that when the sheet is folded a model is created with the one or more textured model components provided on the outer surface of the model; and/or (iv) origami sheet is for folding into a model, the sheet comprising flexible or foldable OLEDs (organic light-emitting diodes) and/or PCBs (printed circuit boards). Also described is application software for the origami sheet and kits comprising the origami sheet and/or stencil.

The present invention relates to sheets used for origami, in particular to sheets used for creating 3D models of animals and people.

Origami is the traditional Japanese art of paper folding and was popularized outside of Japan in the mid-1900s. It has since then evolved into a modern art form. The goal of this art is to transform a flat sheet of material into a finished sculpture through folding and sculpting techniques.

The number of basic origami folds is small, but they can be combined in a variety of ways to make intricate designs. The best known origami model is probably the Japanese paper crane. In general, these designs begin with a square sheet of paper whose sides may be different colours or prints.

Popagami® is a variation of origami in which an origami sheet is folded and sometimes then cut to create a model, for example of an animal. The process of folding a Popagami® sheet is known as Ettesification®.

Whilst many variations and examples of origami exist, they are all concerned with purely aesthetic considerations with a focus on arts and craft. However, very little has been offered in the way of commercially usable origami products.

It is, therefore, an object of the present invention to seek to alleviate the above identified problem.

### SUMMARY OF THE INVENTION

According to one aspect of the present invention, there is provided an origami sheet for folding into a model, the sheet comprising one or more indicators for indicating to a user where to make one or more cuts or tears in the origami sheet, such that, when the sheet is cut or torn as indicated by the one or more indicators and then folded a model is created with the resultant one or more cuts or tears creating a hole in the model through which the inner surface of the model is visible.

The hole allows the model to be used as a finger puppet (for example when in the form of a small circle) or as a container for small gifts (for example when in the form of a large circle). A square or other shapes (for example hearts, hexagons, stars, and so on) can also be created with specifically designed and printed lines that the user cuts with scissors or tears.

Preferably, the one or more indicators comprise perforations in the origami sheet.

According to another aspect of the present invention, there is provided an edible origami sheet for folding into a model.

In another aspect of the present invention, there is provided an origami sheet for folding into a model, the sheet comprising one or more textured model components, such that when the sheet is folded a model is created with the one or more textured model components provided on the outer surface of the model.

In a further aspect of the present invention, there is provided an origami sheet for folding into a model, the sheet comprising flexible or foldable OLEDs (organic light-emitting diode) and/or PCBs (printed circuit board).

Preferably, the origami sheet comprises one or more indicators for indicating to a user where to make one or more cuts or tears in the origami sheet, such that, when the sheet is cut or torn as indicated by the one or more indicators and then folded a model is created with the resultant one or more cuts or tears creating a hole in the model through which the inner surface of the model is visible.

Preferably, the sheet comprises one or more model components such that when the sheet is folded, the one or more model components are provided on the outer surface of the model.

Preferably, a plurality of model components are provided on the sheet such that when the sheet is folded the model components join to form a picture, preferably a complete picture, on the outer surface of the model.

Preferably, the folded model depicts an animal, for example selected from a dog, cat, giraffe, mouse, cow, sheep, big cat, horse, bird, reptile, rabbit or human, and so on. Preferably, the sheet comprises sections from a photograph of an animal, for example a pet or a human.

Preferably, the model depicts a non-living creature, for example a robot.

Preferably, the model depicts a piñata.

In embodiments relating to a piñata, it is preferred that the origami sheet is a square A0 sheet of thin card and that, where a hole is provided in the folded model a sticker is positioned over the hole for containment of sweets within the folded model.

Preferably, the origami sheet comprises patterning, for example associated with a flag or emblem.

Preferably, the patterning is associated with a trade mark or brand image, for example that of a company, airline, shop, individual, sports team, school, college, university, car manufacturer, and so on.

Preferably, the patterning comprises a representation of an animal or character within a book, electronic book, film, television programme or show, cartoon or comic, or other related media.

Preferably, the patterning comprises a representation of a famous person, group (e.g. band), actor, actress, presenter, sportsperson or professional.

Preferably, the one or more indicators comprise one or more lines in the sheet. Preferably, the lines are solid, dotted or dashed lines. Preferably, the one or more lines are perforated.

Preferably, the one or more indicators indicate the position of one or more sections to be removed from the sheet.

Preferably, the one or more indicators are semi-circular in shape.

Preferably, the one or more indicators are provided on opposing sides of the sheet.

Preferably, four indicators are provided, one on each edge of a quadrilateral sheet.

Preferably, the one or more indicators indicate the position of four sections to be removed from the sheet. Preferably, each section to be removed from the sheet is positioned about half way along each edge of the sheet.

Preferably, the one or more indicators comprise a line along which a cut or tear should be made and optionally one or more lines along which one or more folds should be made such that, when the sheet has been cut or torn and folded as indicated by the one or more indicators, the one or more folds provide a reinforced edge for a hole in the folded model.

For example, in some embodiments, the sheet comprises four cutting or tearing indicator lines which indicate that a cut or tear should be made, each of the four indicator lines extending inwardly from separate edges of the sheet towards the centre of the sheet at a position about half way along said edges. A user may then fold the sheet away from the cut or tear lines to create triangular holes in the edge of the sheet. When the sheet is folded to form a model, the triangular holes will align to form a square hole in the model, the sides of which are reinforced by folds.

Preferably, the origami sheet comprises one or indicators for indicating to a user where to make one or more hook cuts or tears in the origami sheet, such that, when the sheet is cut or torn as indicated by the one or more indicators and then folded a model is created with the resultant one or more cuts or tears creating a hook from which the model can be suspended.

A hook is particularly appropriate in relation to embodiments of the invention which relate to a piñata.

Preferably, the origami sheet comprises one or more indicators for indicating to a user where to make one or more feature cuts or tears in the origami sheet, such that when the sheet is cut or torn as indicated by the one or more indicators and then folded a model is created and the resulting one or more feature cuts or tears allow one or more areas of the surface of the model to be folded away from the outer surface of the model. For example, in some embodiments, a feature such as an ear, tongue, horns, eyes and/or teeth may be “folded out” to protrude from the surface of the model.

Preferably, the one or more indicators comprise perforations in the origami sheet.

Preferably, the one or more indicators comprise perforated lines for allowing one or more features to “fold-out” from the folded model. For example, in some embodiments, the origami sheet comprises two perforated lines each corresponding to an ear and/or perforated lines corresponding to one or more of teeth, eyes, tongue, horns, eyes, and so on. When the sheet has been folded into a model, the perforations can be broken and the ears and/or other features folded out to protrude from the surface of the model.

Preferably, the sheet is substantially square.

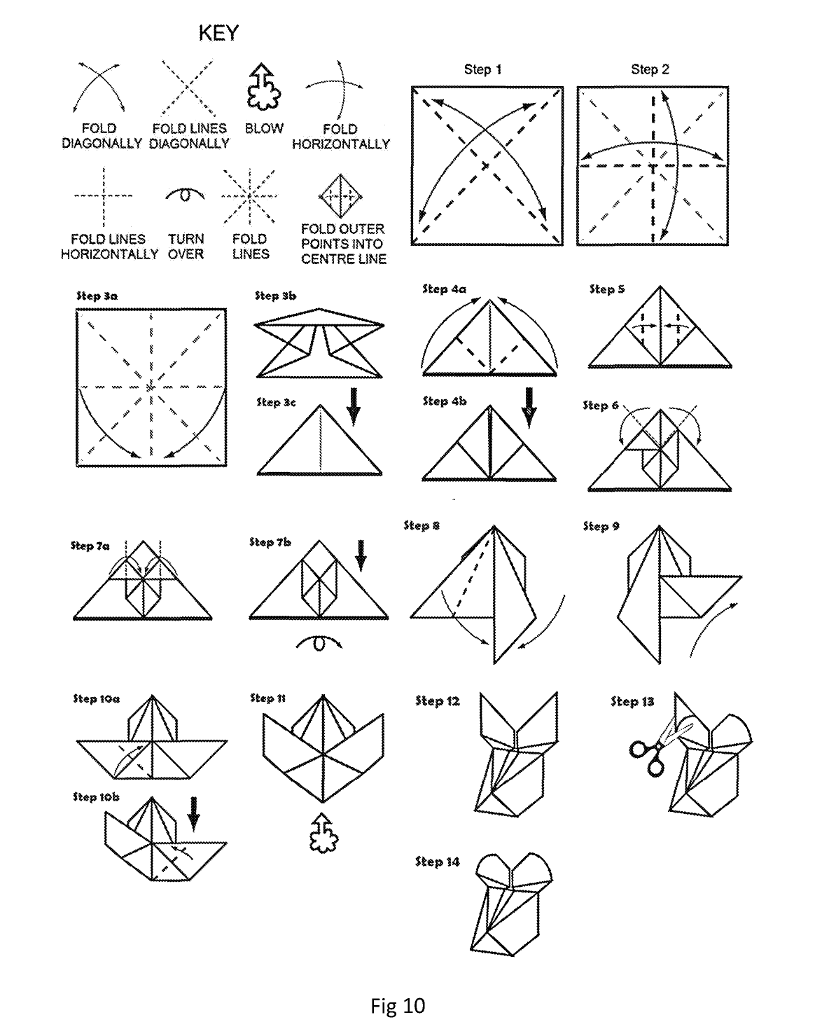

Preferably, the sheet is for folding in accordance with the instructions provided in FIG. 10 and/or as detailed further below.

Preferably, the sheet comprises a textured surface.

Preferably, one or more of the model components are provided with a textured surface. This is particularly advantageous because if the entire surface of the origami sheet is provided with a textured, for example furry surface, the origami sheet becomes very difficult to fold. In contrast, by providing only those parts of the origami sheet that will form the outer surface or part of the outer surface of the folded model with a textured, for example furry surface, it becomes much easier to fold the origami sheet into the folded model.

Preferably, the textured surface is a furry surface.

Preferably, the origami sheet comprises a material which changes colour in response to heat or light, for example a thermochromatic material, such as a thermochromatic plastics material.

Preferably, the origami sheet comprises fluorescent and/or phosphorescent dyes and/or inks. Preferably, the one or more model components comprise fluorescent and/or phosphorescent dyes and/or inks. Preferably, one or more sections of the sheet which will form the interior of a folded model are provided with fluorescent and/or phosphorescent dyes and/or inks.

Preferably, the origami sheet comprises one or more flexible or foldable OLEDs (organic light-emitting diode) and/or one or more PCBs (printed circuit board). As a result, the folded models can display an image, which appears to ‘move’ on the surface or change the appearance of the surface of the model.

Preferably, the origami sheet comprises an edible material, preferably selected from edible paper, for example rice paper, edible organic polymers and gelatine sheets.

Preferably, the origami sheet comprises a baking proof material, for example grease-proof paper. As such, the sheet can be used to create a model for use in baking and for use as a casing to fill with food items, both hot and cold.

Preferably, the origami sheet comprises one or more cut-outs. Preferably, the one or more cut-outs reduce the thickness of the base of the model when folded.

Preferably, the one or more model components are arranged as shown in FIG. 2.

Preferably, the origami sheet comprises one or more elements, for example raised elements which indicate the orientation of the sheet to a blind or partially sighted user. Preferably the raised elements are in the form of Braille.

Preferably, the origami sheet is selected from a square A0 A1, A2, A3, A4 or A5 sized sheet of material.

The origami sheets of the present invention can be provided in a number of different print finishes. For example, in some embodiments, the one or more components comprise sections of a picture or photograph, preferably of a person or animal such that when the sheet is folded, the model resembles the completed picture or photograph, preferably a person or animal.

In another aspect of the present invention, there is provided application software (“an app”) to provide instructions on a mobile device, such as a Smartphone or a tablet computer, for creating an origami sheet of the present invention.

Preferably, the application provides instructions for converting a picture or photograph into an origami sheet of the present invention, wherein the one or more components comprise sections of a picture or photograph, preferably of a person or animal, such that when the sheet is folded, the model resembles the picture or photograph, preferably a person or animal.

In further embodiments of the present invention, the model can be recreated in a different material, for example selected from glass, metal or plastic.

Preferably, the origami sheet comprises a foil material such that the folded model can be filled with helium and used as a balloon.

Preferably the origami sheet comprises a valve which is positioned such that it can be secured within a hole formed within the folded model.

In another aspect of the present invention, there is provided a stencil for creating an origami sheet in accordance with the present invention. Preferably, the stencil comprises one or more feature indicators for indicating to a user where to place one or more features on an origami sheet. Preferably, the one or more feature indicators are selected from one or more eye indicators, one or more mouth indicators, one or more ear indicators, one or more mouth indicators, one or more cut-out or tear-out indicators, one or more nose indicators and one or more fold line indicators.

Preferably, the stencil comprises one or more cut-out or tear-out indicators for indicating to a user where to place one or more indicators on the origami sheet such that when the origami sheet is cut or torn as indicated by the one or more indicators and then folded, a model is created with the one or more cuts or tears creating a viewing hole in the model through which the inner surface of the model is visible.

Preferably, the stencil comprises one or more cut-out or tear-out indicators for indicating to a user where to place one or more indicators on the origami sheet which comprise a line along which a cut or tear should be made and optionally one or more lines on the sheet along which one or more folds should be made such that, when the sheet has been cut or torn and folded as indicated by the one or more indicators, the one or more folds provide a reinforced edge for a hole in the folded model.

Preferably, the stencil is for creating different sized origami sheets, for example selected from square A0 A1, A2, A3, A4 and A5 sized sheets of material.

Preferably, the stencil comprises differently positioned feature indicators corresponding to different sized origami sheets.

Preferably, the stencil comprises one or more feature lines upon which one or more feature indicators are provided. Preferably, the one or more feature lines are selected from one or more eye indicator lines, one or more mouth indicator lines, one or more ear indicator lines, one or more mouth indicator lines, one or more cut-out or tear-out indicator lines, one or more nose indicator lines and one or more fold line indicator lines.

Preferably, the stencil comprises a rigid material, such as a rigid plastics material.

Preferably, the stencil comprises a flexible material, such as flexible plastic material.

Preferably, the stencil is transparent.

Preferably, the one or more feature indicators and/or one or more indicator lines comprise indentations or holes and/or grooves or channels in or through the surface of the stencil.

Preferably, the stencil comprises one or more elements, for example raised elements, which indicate the orientation of the sheet to a blind or partially sighted user.

Preferably, the one or more feature indicators and/or one or more indicator lines are provided in the form of markings on the surface of the stencil.

Preferably, the stencil is a platen. In this respect, in one aspect of the present invention there is provided a platen for creating an origami sheet in accordance with the present invention.

According to another aspect of the present invention, there is provided a model produced by folding an origami sheet as described herein. For example, in accordance with the preferred features of the folded model described herein, the model could be selected from a balloon or piñata.

In another aspect of the present invention, a plastic tree is provided upon which models of the present invention can be placed. In some embodiments, the tree comprises a plurality of lights over which models of the present invention can be placed. This is particularly the case for embodiments of the present invention which comprise a viewing hole through which one or more lights may be passed such that the model is illuminated.

In another aspect of the present invention, there is provided an origami kit comprising an origami sheet as described herein and/or a stencil as described herein.

Preferably, the kit comprises instructions for folding the origami sheet. Preferably, the instructions comprise those provided in FIG. 10, as detailed further below.

Preferably, the kit comprises instructions for using a stencil as described herein.

Preferably, the kit comprises one or more accessories for use with the origami sheet and folded models of the present invention. Preferably, the one or more accessories are for attachment to the folded model. Preferably, the one or more accessories are selected from ears, noses, antlers, eyes, teeth, horns, whiskers, wigs, beards, and so on.

Preferably, the kit is a piñata kit and comprises an origami sheet of the present invention which, when folded, forms a piñata. Preferably, the piñata kit comprises one or more blindfolds, stickers, soft sticks and/or string to hang up the piñata.

Preferably, the kit is a balloon kit and comprises an origami sheet of the present invention which, when folded, forms a balloon. Preferably, the balloon kit comprises a valve or stopper.

### DETAILED DESCRIPTION

Example embodiments of the present invention will now be described with reference to the accompanying figures, in which

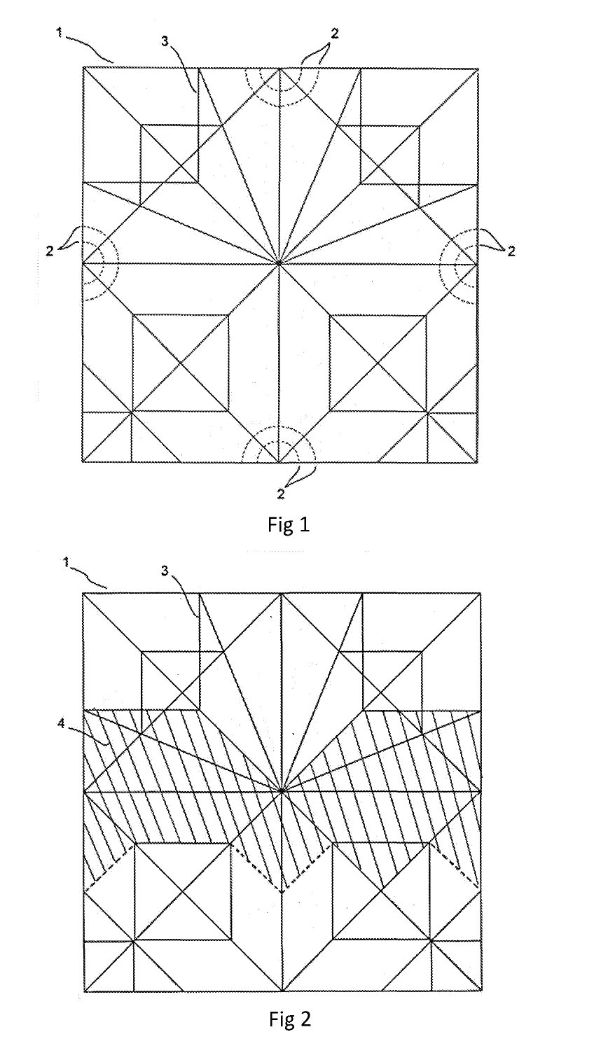

FIG. 1 is a front view of an origami sheet of the present invention which comprises a plurality of indicators for indicating to a user where to make cuts or tears which result in a viewing hole;

FIG. 2 is a front view of an origami sheet of the present invention showing the position of model components;

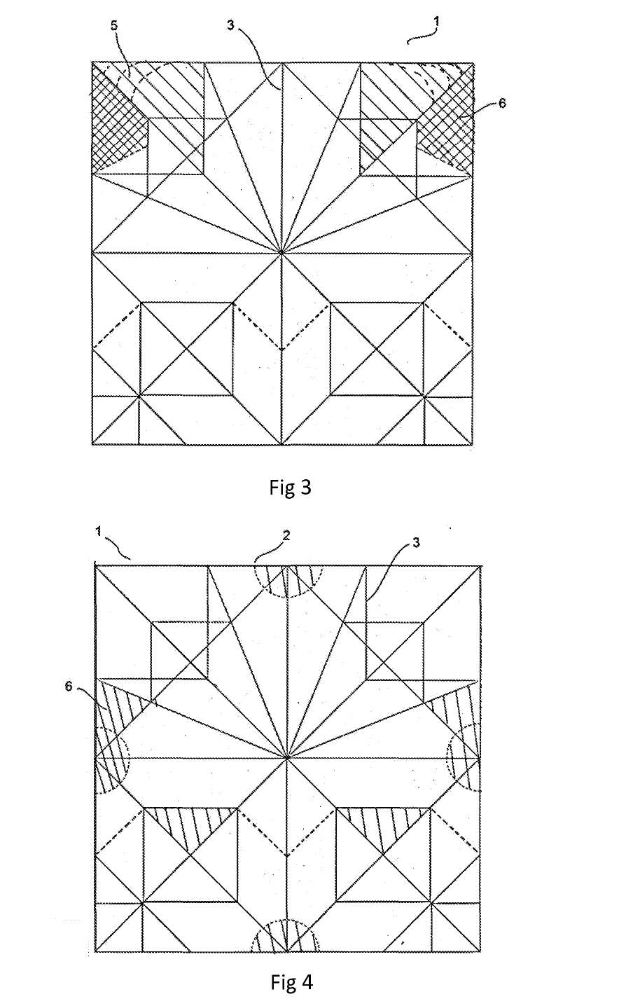

FIG. 3 is a front view of an origami sheet of the present invention showing the position of model components relating to ears of an animal;

FIG. 4 is a front view of an origami sheet of the present invention showing possible positions of areas for branding, text and logos;

FIG. 5 is rear view of an origami sheet of the present invention showing areas of the sheet which are visible inside the folded model;

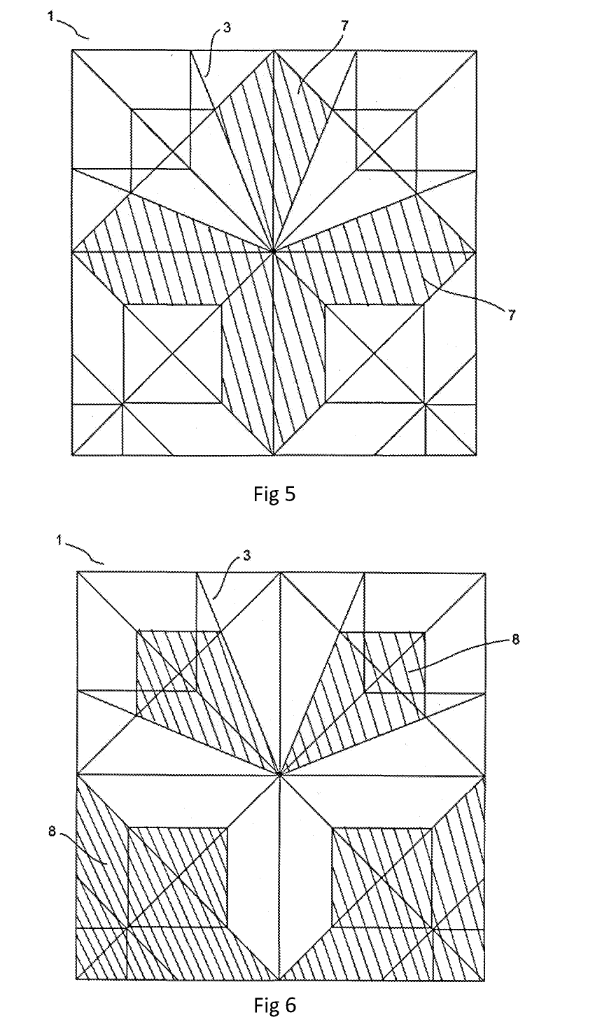

FIG. 6 is a rear view of an origami sheet of the present invention showing areas of the sheet which are not visible inside or outside of the folded model;

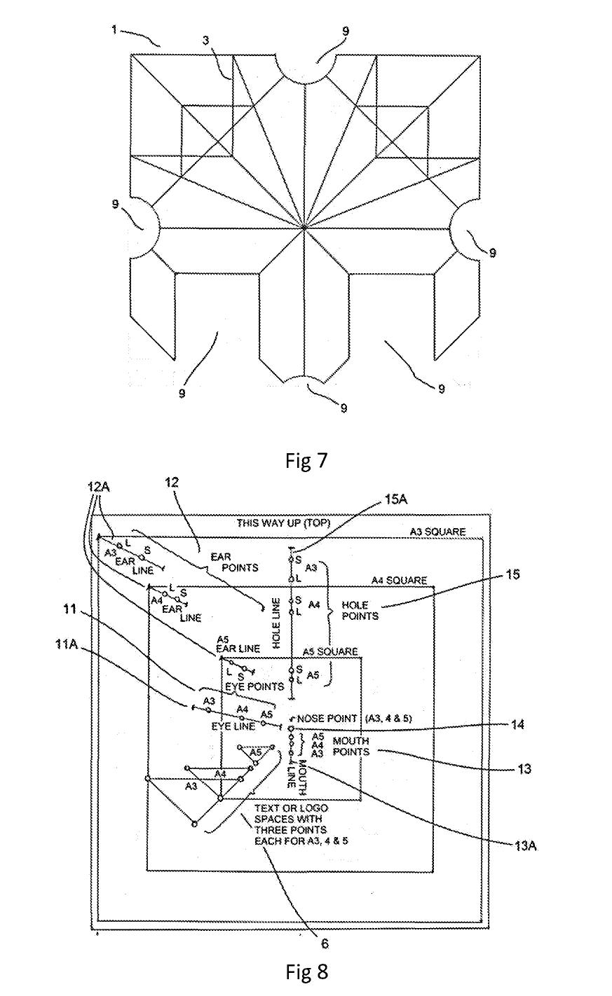

FIG. 7 is an origami sheet of the present invention made from an edible material;

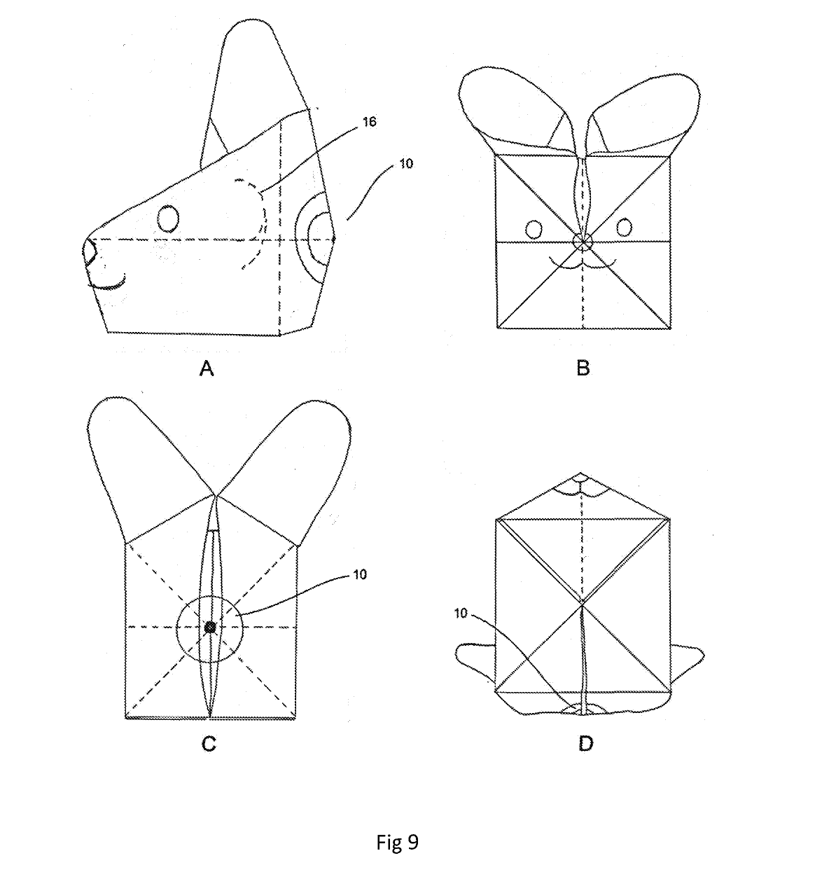

FIG. 8 shows a stencil according to the present invention;

FIGS. 9A to 9D show an example of a model produced by an origami sheet of the present invention; and

FIG. 10 shows folding instructions for folding an origami sheet of the present invention into a model.

The present invention relates to origami sheets for folding into models, for example animals.

The origami sheets of the present invention have specific and unique folding instructions to create three-dimensional (3D) models. The models can be of animals, people, mythical or fantasy creatures as well as other images such as flags, logos and other artwork.

The combination of different foldable media, sizes and an infinite variety of design styles, artwork and images create a huge potential product range for the origami sheets of the present invention.

The origami sheets and resulting models of the present invention have a number of possible uses, for example as 3D and novelty calling cards, business cards and for advertising logos and company details, as origami sheets that have more specific folds and directions from the original origami design; as gift tags with areas to write names; as containers or packaging for gifts or products, with place to write names; as greetings cards; as finger puppets, as desktop calendars; as notepads with a design for folding on the back, for providing a message or picture (for example a logo puzzle or greeting) which may be visible or hidden within the model when folded; as part of a kit for a piñata; as part of toy hampers or bags such as those on long-haul flights; as bespoke designs for companies that use as advertising or have markets which include animals, pets, children, parents or arts/crafts; and as part of an educational or ESL (English as a second language) package. The origami sheets of the present invention can incorporate logos, brand names, QR (quick response) codes and company details.

The models of the present invention can be used with a specially designed glove and green sleeve for animation and YouTube productions.

The origami sheets of the present invention can be provided in different sizes from about lcm square to over 200 cm square.

The origami sheets of the present invention can be made from many different materials, for example different paper types, foldable plastics, metal foil and so on.

In embodiments relating to edible sheets, the origami sheets can be made using rice paper and edible dyes. The edible sheets of the present invention can be used as edible packaging for food and as containers for cooking food, for example in bakery.

In some embodiments, the origami sheets of the present invention comprise flexible or foldable OLEDs (organic light-emitting diode) and/or PCBs (printed circuit board). As a result, the folded models can appear to ‘move’ on the surface or change appearance.

Foldable OLEDs have substrates made of very flexible metallic foils or plastics. Foldable OLEDs are very lightweight and durable. Their use in devices such as cell phones and PDAs can reduce breakage, a major cause for return or repair. Potentially, foldable OLED displays can be sewn into fabrics for “smart” clothing, such as outdoor survival clothing with an integrated computer chip, cell phone, GPS receiver and OLED display sewn into it.

Ultra-lightweight, thin form flexible OLEDs are thinner and lighter weight than other displays. This means that cell phones, portable computers, wall-mounted televisions and other products that use them can also be lighter and smaller. Flexible OLEDs can also be more durable—less breakable and more impact resistant—than other displays. With glass breakage a major cause of display-containing product returns, this is a highly desirable commercial alternative. Flexible OLEDs may be manufactured on a variety of substrates and can be built on optically-clear plastic films and thin, bendable metallic foils. Such displays may be made to bend, flex and conform to many surfaces.

Different visual styles of the origami sheets can be provided, such as watercolour, pop art, modern art, manga, cartoon, realistic cartoon, photo-shopped/digitally enhanced images, colour-in designs, and so on.

Within this specification, the term “front” means the surface of an origami sheet which will predominantly form the outer surface of the folded model. The front is the side upon which one or more model components are placed in order that the model components appear on the outer surface of the folded model.

Within this specification, the term “rear” means the surface of the origami sheet behind the front surface, i.e. the reverse of the sheet compared to the front.

Within this specification embodiments have been described in a way which enables a clear and concise specification to be written, but it is intended and will be appreciated that embodiments may be variously combined or separated without parting from the invention. For example, it will be appreciated that the preferred features of the present invention are applicable to all aspects of the present invention, individually and in combination.

With reference to FIG. 1, there is shown an origami sheet 1 which comprises a plurality of indicators 2 for indicating to a user where to make cuts or tears which result in a viewing hole 10 (as shown in FIGS. 9A-D). Also shown are fold lines 3, which are created in accordance with the folding instructions described herein.

With reference to FIG. 2 there is shown a front view of an origami sheet 1 of the present invention showing an area 4 in which one or more model components may be positioned. In this respect, the area shown will be visible on the outer surface of the folded model.

With reference to FIG. 3, there is shown a front view of an origami sheet 1 of the present invention showing an area 5 corresponding to the ears of a folded model and an area 6 in which branding, text, logos, copyright notices, and so on could be positioned. In this respect, as with area 4, areas 5 and 6 will be visible on the outer surface of the folded model. The detail of the ear shows that many different ear shapes can be designated with a scissor cut line. On the back of the ears a space is available for the user to write in. For example, the design can incorporate a ‘TO:’ name and a ‘FROM:’ name to use as a gift tag or container.

With reference to FIG. 4 there is shown a front view of an origami sheet 1 of the present invention showing further areas 6 for branding, text and logos. FIG. 4 also shows the positions of indicators 2 for indicating to a user where to make cuts or tears which result in a viewing hole 10 (as shown in FIGS. 9A-D).

With reference to FIG. 5 there is shown a rear view of an origami sheet 1 of the present invention showing areas 7 of the sheet which are visible inside the folded model. These areas 7 can be provided with branding, text, logos, and so on, which are only then visible inside the folded model. The inclusion of the areas 7 is particularly suited to embodiments of the present invention comprising one or more indicators 2 for indicating to a user where to make cuts or tears which result in a viewing hole 10.

With reference to FIG. 6, there is shown a rear view of an origami sheet 1 of the present invention showing areas 8 of the sheet which are not visible inside or outside of the folded model. These areas 8 can be provided with branding, text, logos, and so on, which are only visible when the folded model is subsequently unfolded. As such, these areas can be used for providing secret messages not normally visible in the folded model.

With reference to FIG. 7, there is shown an origami sheet 1 of the present invention made from an edible material. In this example, the origami sheet 1 is provided with cut-outs 9. Some of the cut-outs 9 are provided in a base region which reduces the thickness of the base of the model when folded. In order to assist with stability of the folded model, the base can be glued. Other cut-outs may be provided which correspond to ears (not shown) or those areas which might be removed as indicated by one or more indicators to provide a hole in the folded model. With cut-outs already provided, rather than the origami sheet being provided with indicator lines, the origami sheet is better adapted for use as a cooking or food presentation aid due to the reduced risk of contamination from scissors or knives used to cut the origami sheet. An edible origami sheet can be made from any suitable edible material, such as rice paper or gelatine sheet.

With reference to FIG. 8, there is shown a stencil according to the present invention. The stencil can be used to produce a user-defined design which can then be folded as described herein to a model having the user defined design. For example, a user may create their own cartoon animal design or match up the stencil to a photograph of the head of an animal or person to create a 3D model of the head of the person or animal.

The stencil comprises indicators for eyes (11), ears (12), mouth (13) and nose (14), with the indicators (11, 12, 13) provided on eye lines (11A), ear lines (12A) and mouth lines (13A). Also provided are hole indicators (15) provided on a hole line (15A). The positions of the indicators (11, 12, 13) correspond to different sizes of square paper as indicated, for example A3 square, A4 square and A5 square. The indicator lines (e.g. eye lines, ear lines, mouth lines, hole lines) allow a user to adapt the stencil to different paper sizes, for example those falling between A3, A4 and A5 sized paper. The nose indicator (14) is in the centre of the sheet and so is in the same position for all sizes of paper. Also shown in the stencil are possible areas 6 for the provision of branding, text, logos, and so on. For the sake of clarity and ease of understanding, the stencil shown in FIG. 8 is only provided with indicators and indicator lines on the left hand side. However, it will be appreciated that a stencil according to the present invention would be provided with indicators and indicator lines on both the left and right hand sides of the stencil, with the right hand side being a mirror image of the left hand side.

With reference to FIGS. 9A to 9D, there are shown side (9A), front (9B), rear (9C) and underside (9D) views of an example of a model produced by an origami sheet of the present invention. FIG. 9A shows the position of indicators (16) in the form of perforated lines which, when cut or torn, allow additional features to be folded out away from the surface of the model.

With reference to FIG. 10, there is shown folding instructions for folding an origami sheet of the present invention into a model. The folding instructions may comprise the following steps and are with reference to an embodiment of the present invention which comprises one or more model components which, together, form a face of an animal:—

Step 1: Place one of the designed sheets with the front face looking away from you so that you have the blank side or message side facing you. Take one of the top corners of the design and match it up to the bottom corner diagonally across the sheet to make a triangle. Make sure that the corners and the two edges match up before creasing. Then unfold. NOTE: A good method for creasing is to start in the middle, checking that the edges are matched, and then run your finger to the edges on each side. Initially do it lightly and then check that the edges and corners are all well matched, then it is still possible to readjust before reinforcing the crease. Don't worry if too much if the crease is a little out, but if more than a few mms adrift then it is worth readjusting and doing a new and better matched crease. Repeat this with the other two diagonally across corners and again unfold. You should now have two creases that make an X.

Step 2: Turn the sheet over so that the front face is looking at you with ears at the top and mouth at the bottom. Take the top edge and fold over onto the bottom edge of the design, before creasing make sure the two edges meet up at the corners and along the edge. Then after making a crease, unfold. Repeat this from left to right and unfold. At this point you should have four creases, a cross (+) and an X.

Steps 3a to 3c: Turn over your sheet so you are again looking at the face. If you push in the middle on the underneath of the sheet the design should have its nose pointing up towards you with four points on each corner. If you bring the two left-hand points together you will notice that the left eye disappears into a triangle. Do you the same with the two right-hand points so that the right eye also disappears and flatten the design down into a triangle. You should now have two printed sides visible on a triangle, one side with have the mouth, the other side the ears. The eyes should not be visible, if there are you need to start this step again with the design correctly oriented. In origami this is known as the water-bomb base.

Step 4a/b: Now with the triangle mouth side facing up, turn the design around so the nose is pointing away from your body. At the bottom two corners of the design you will see that each point has two flaps of folded paper. Taking only the top flap point on one side of the design, fold this to the tip of the nose—the point furthest from you and crease it down well, making a triangle. Repeat this on the other side. You should now still have a triangle with the nose pointed away from you but with two triangles that form a square/diamond in the middle.

Step 5: Locate the centre of this square; it can help if you make a pen mark at this centre. Rotate your paper 90 degrees clockwise so that the nose points to your left. The two triangles that form the square in the middle should now have one of its points facing to you. Take the corner point of this square and fold the centre of this square in the middle of this sheet and crease it down. Rotate your paper 180 degrees so that the nose is now pointing to your right and repeat this fold on the other side. The two points you folded into the centre would ideally almost be touching at the centre point of square.

Step 6: Rotate the design so that the nose is again pointing away from you. You should now see two flaps at the top. The square has now turned into a bowtie shape (two triangles with their centre points touching in the middle (><)). Looking at the left side take the left hand flap and fold it over the lower half of the left triangle (bowtie). The flap will make another smaller triangle that is also pointing away from you. Repeat this on the other side—the nose and mouth of the design should now be visible.

Step 7a/b: Remembering where the centre is that you marked with a pen, you now have to fold the outer points back on top of these two triangles into this centre point making two smaller triangles. If you start with the left hand triangle the left point folds to the centre and then you repeat this with the right hand triangle, folding the right-hand point to the centre. The two smaller triangles you created will now fit into a pocket that is underneath these flaps. Lift the flaps out of the way and you will see will find a pocket between the topmost layer and the one immediately below it. You will need to open this pocket with a finger nail or pen and when open the flap should neatly tuck inside the pocket. Repeat this on the other side and smooth down, this ‘locks’ the base into position. You have now completed the base.

Step 8: Turn your sheet over to the ear side of the design and point the nose away from you. The folds on this side are not the same as the base. You have two triangles and a centre line down the middle, in the manner you fold paper airplanes you are folding the two triangle edges coming from the nose down the central line in the middle of the triangle forming a dart shape.

Step 9: You should now have two triangles with different lengths to their three sides. At the bottom are the two shortest sides of the triangle coming to a point that is pointing to you. Take the right hand point and pull it up and to the right, keeping the angle of the fold at 45 degrees and the top edge level and parallel to the bottom of the main triangle. At the bottom the flap you create will be fully extended so it no longer protrudes below the base of main triangle. Repeat this on the left hand side so that the top edges of these two flaps make a parallel straight line with the base that is closest to you.

Step 10a/b: You now only have two more folds to form the ears. On the very bottom edge nearest to you there should be two points making a wide angle of about 120 degrees to adjacent edge. These points need to be folded up to the central line so that when you have folding both sides the points meet and a new point is created at the bottom edge of the sheet.

Steps 11 and 12: At the base you now have a point facing to you. If the sheet comprised semi-circular indicators on each edge to define different sized holes in the folded model, you will see two concentric black lines. The smallest one, once cut with scissors, will make a hole so design can be used as a finger puppet. The larger circle will make a hope big enough so sweets and gifts can be placed inside. If you blow into this hole at the back of the design (or if no indicators were provided into the very small hole formed by the various folds at the back of the design) it will inflate. You can also use a pen or pencil to push out the sides, push down the base and back.

Step 13: To finish, trim the ears, for example by cutting off the white areas shown by the black lines (if these are provided). You can also curl the ears to give a more curved and natural look.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications are covered by the appended claims.

1. A stencil for creating different sized origami sheets, wherein
the origami sheet is for folding into a model, the sheet comprising one or more indicators for indicating to a user where to make one or more cuts or tears in the origami sheet, such that, when the sheet is cut or torn as indicated by the one or more indicators and then folded a model is created with the resultant one or more cuts or tears creating a hole in the model through which the inner surface of the model is visible.

2. A stencil according to claim 1, comprising one or more feature indicators for indicating to a user where to place one or more features on an origami sheet, wherein differently positioned feature indicators correspond to different sized origami sheets.

3. A stencil according to claim 1, comprising one or more cut-out or tear-out indicators for indicating to a user where to place one or more indicators on the origami sheet such that when the origami sheet is cut or torn as indicated by the one or more indicators and then folded, a model is created with the one or more cuts or tears creating a viewing hole in the model through which the inner surface of the model is visible.

4-5. (canceled)

6. A stencil according to claim 1, comprising one or more feature lines upon which one or more feature indicators are provided.

7. A stencil according to claim 6, wherein the one or more feature indicators and/or one or more feature lines comprise indentations or holes and/or grooves or channels in or through the surface of the stencil.

8. A stencil according to claim 1, comprising one or more elements which indicate the orientation of the sheet to a blind or partially sighted user.

9. A stencil according to claim 1 wherein the stencil is a platen.

10-34. (canceled)

35. An origami sheet for folding into a model wherein the sheet comprises one or more indicators for indicating to a user where to make one or more cuts or tears in the origami sheet, such that, when the sheet is cut or torn as indicated by the one or more indicators and then folded a model is created with the resultant one or more cuts or tears creating a hole in the model through which the inner surface of the model is visible, and wherein the sheet comprises a foil material such that the folded model can be filled with helium and used as a balloon.

36. An origami sheet according to claim 35, comprising a balloon valve or stopper.

37. Application software for providing instructions on a mobile device, such as a Smartphone or a tablet computer, for creating an origami sheet for folding into a model, wherein the application software provides instructions for converting a picture or photograph into the origami sheet wherein the sheet comprises one or more indicators for indicating to a user where to make one or more cuts or tears in the origami sheet, such that, when the sheet is cut or torn as indicated by the one or more indicators and then folded a model is created with the resultant one or more cuts or tears creating a hole in the model through which the inner surface of the model is visible, wherein the sheet comprises one or more model components such that when the sheet is folded, the one or more model components are provided on the outer surface of the model and wherein the one or more components comprise sections of the picture or photograph such that when the sheet is folded, the model resembles the picture or photograph.

38-57. (canceled)

58. A stencil according to claim 2, wherein the one or more feature indicators comprise indentations or holes and/or grooves or channels in or through the surface of the stencil.
